(19) United States
(12) Patent Application Publication
(10) Pub. No.: US 2005/0095336 A1
(43) Pub. Date: May 5, 2005

(54) Low carbohydrate ice cream

(76) Inventor: Pete Maletto, Long Branch, NJ (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/701,254

(22) Filed: Nov. 4, 2003

(51) Int. Cl. A23G 9/00

(52) U.S. Cl. 426/565

(57) ABSTRACT

A low carbohydrate ice cream formulation that is rich in fiber is provided. The subject ice cream base formulation is free of milk and, hence, lactose and is comprised of heavy cream, water, maltodextrin soluble fiber, polydextrose, whey protein concentrate, glycerin, egg yolks, lecithin, xanthan gum, microcellulose gum, a mixture of locust bean gum and carrageenan gum, a mixture of mono- and di-glycerides of short chain fatty acids and an artificial sweetener that is a combination of acesulfame potassium and sucralose. Ice cream prepared by blending a suitable flavor into the subject base formulations is esthetically comparable to conventional premium ice cream.

### FIELD OF THE INVENTION

The present invention relates to ice cream formulations that are low in carbohydrates, yet possess a texture and flavor closely resembling conventional premium ice cream formulations.

### BACKGROUND OF THE INVENTION

There has been an increasing public awareness of fitness, as well as the percentage of individuals who are overweight, in the United States, and other countries as well. It has been estimated that the average percentage of Americans attempting to adhere to some type of diet or weight loss regimen on a given day can be one-third of the population or higher. This number varies seasonally and typically is higher, for example, after the holidays at the end of the year. Although a majority of these individuals are simply trying to lose weight, there is a substantial percentage who are practicing restrictive diets because of various medical conditions, for example, diabetes, heart disease, hypertension and the like.

The issues of overweight and obesity in America are on the rise, which is evident by the fact that America is generally regarded as the fattest country in the world. A common practice among individuals trying to reduce their intake of carbohydrates in relation to protein is to increase their intake of meat. However, although high in protein, meats typically contain fat, saturated as well as unsaturated fat, which can be a problem for those who must maintain certain cholesterol levels because of various pre-existing medical conditions and/or the prophylaxis of conditions such as heart disease, hypertension and the like. For this reason, there has been an emphasis on the development of foods and food preparations that might allow the individual to reduce the amount of meat in his or her diet without sacrificing the esthetic aspects of foods. As would be expected, therefore, the primary emphasis in the development of low carbohydrate foods is the esthetics, i.e. aroma, taste and texture or mouth feel, since it is generally recognized that so-called diet foods have little chance of survival in the marketplace if they do not have at least a tolerable taste and mouth feel. It will be appreciated that there is significant competition to achieve such products whose esthetic characteristics most closely resemble the corresponding traditional high carbohydrate product.

Ice cream, because of its almost universal appeal and high carbohydrate content, has been the focus of numerous attempts to formulate low carbohydrate, “no sugar added” products. The predominant formulations developed in this effort have been no sugar added formulations. Unfortunately, these products still contain high amounts of carbohydrates, primarily due to the high lactose content from milk.

U.S. Pat. No. 4,663,176 to Arden provides a frozen chocolate mousse confection comprising heavy cream, water, cane sugar, dried egg yolks and flavors, i.e. chocolate, cocoa, instant coffee and vanilla extract. The disclosed formulations, all of which contain sugar, may also contain lecithin.

U.S. Pat. No. 4,657,200 to Serpelloni et al discloses a sugarless ice cream formulation characterized by a sweetening and textural agent comprising a mixture of polyols, the formulation otherwise comprising lactose-containing skim milk, fats, stabilizers, emulsifiers, flavors and artificial sweeteners. The skimmed milk may be replaced by one of caseinates, ultra-filtered milk proteins, ultra-filtered serum proteins, buttermilk, ultra-filtered buttermilk and heat-coagulated, de-lactosed serum proteins.

U.S. Pat. No. 5,084,295 to Whelan et al. discloses ice cream formulations containing fat prepared by forming a pre-emulsion of 30% to 100% edible, wholly or partially nondigestible, intermediate melting polyol polyesters, milk solids, a sweetener, a stabilizer and an emulsifier, combining the pre-emulsion with a triglyceride fat, added milk solids other than fat, added sweetener and added water, then forming a second emulsion and at least partially freezing it.

U.S. Pat. No. 5,145,698 to Cajigas provides an instant yogurt formulation that can be reconstituted into either yogurt or a yogurt drink comprising a lactobacillus culture, drymilk yogurt powder, up to 20% of one or more hydrocolloids and 10-30% of a dairy product selected from whey, de-lactosed whey, powdered milk and powdered cultured milk.

U.S. Pat. No. 5,328,710 to Malone et al provides soft serve frozen desserts having specific concentrations of lactose and a combination of hydrocolloids, specifically lecithin, pectin and a gum such as xanthan gum or locust bean gum. It is stated that concentrations of these hydrocolloids below a stated level adversely affects the properties of the final preparation, and increasing the concentration above a stated level, although not materially adverse to the properties of the final preparation, does not improve them. The remainder of the preparations include skim milk, cream, corn syrup and corn syrup solids, and sugar.

U.S. Pat. No. 5,358,728 to Martin et al. provides non-fat frozen dairy desserts comprising non-fat milk solids, a sweetener, corn syrup solids, dextrins, unmodified starch, polyphosphate complexing salt and a stabilizer that may include one or more hydrocolloids. It is evident that the preferred sweetener is a natural sweetener, such as sucrose.

U.S. Pat. No. 6,511,694 to Huang et al. discloses a sweetener composition useful for frozen desserts consisting of 30% to 90% sucrose and 70% to 10% maltose. Frozen desserts made with the disclosed sweetener are stated as being substantially free of gums and sugar alcohols. The formulation is compared favorably against other frozen dessert formulations. One such dessert, shown for comparison in Table 5, contains condensed skim milk, cream (40% fat), egg yolk, crystalline sucrose, crystalline dextrose, crystalline lactose, a mono- and di-glyceride polysorbate emulsifier, several gums, corn syrup solids and water.

It is evident that there have been numerous attempt to formulate ice cream formulations that are low in carbohydrate content, yet retain as many of the advantageous and familiar properties of conventional premium ice cream as possible. Of these properties, the most important is taste and texture or mouth feel because, if these are unacceptable, the product will not be successful in the marketplace regardless of how low the carbohydrate content. Such a ice cream formulation that is additionally rich in fiber has been found in accordance with the present invention.

### SUMMARY OF THE INVENTION

An ice cream formulation is provided that is low in carbohydrate content and high in fiber, yet possesses a taste, texture and feel in the mouth closely resembling traditional premium ice cream formulations. The formulations of the present invention are characterized by a combination of ingredients that make up for the sugar, corn syrup and the like typically included in premium ice cream. The formulations contain a variety of colloids, polydextrose, glycerin, whey protein concentrate, maltodextrin fiber, a mixture of mono- and di-glycerides, and is sweetened by a combination of acesulfame potassium and sucralose. The product is prepared in accordance with procedures typically used for conventional premium ice cream products. The ice cream product may contain any of the flavors conventionally used in ice cream formulations with the caveat that the flavor must be at least low carbohydrate. Such flavors may add some sugar alcohols to the overall formulations, but in minor amount compared to the levels typically found in conventional premium and super premium ice creams.

### DETAINED DESCRIPTION OF THE INVENTION

In accordance with the present invention, there is provided an ice cream base formulation that is low in carbohydrate content and high in fiber and fat, yet is in all respects comparable to conventional premium ice cream. Most important, the ice cream formulation of the invention is comparable to conventional ice cream in taste, texture and mouth feel. The subject formations are a unique blend of ingredients designed to yield the advantageous properties that render it comparable to conventional ice cream. The ingredients of the subject formulations are as follows.

The principal ingredients of the subject formulations are heavy cream and water. Heavy cream is the primary source of fat therein. More specifically, heavy cream is typically at least about 40% butterfat. Heavy cream comprises from about 35% to about 45% by weight, preferably about 41% by weight, of the present formulations. The low carbohydrate ice cream in accordance with the present invention is unique in having such a high content of heavy cream in comparison to the amounts present in conventional ice cream formulations. Conventional ice creams combine milk and cream which acts to lower the overall cream usage. However, the milk also markedly increases the content of lactose sugar and, therefore, the carbohydrate content. The increased amount of heavy cream in the subject formulations compensates for the absence of milk therein, and in combination with water, provides an ice cream base that is substantially free of milk or skim milk. By this is meant that milk or skim milk is not intentionally added in any form as an ingredient of the formulation. However, the possibility cannot be ruled out that a minor quantity of milk, or a milk product might be added as a component of another ingredient, primarily a flavor component. The subject formulations contain water in from about 37% to about 45% by weight, preferably about 41% by weight.

The subject ice cream formulations are unique in that, in addition to being low in carbohydrate, they have a significant fiber content. The primary fiber ingredient is polydextrose. This material, which is available commercially as Litesse from the Danisco Company, is a non-digestible polysaccharide that contains about 90% by weight soluble fiber. In addition to providing fiber in the subject formulations, polydextrose functions as a bulking agent in a manner similar to the effect of sugar in conventional ice cream formulations. The subject formulations contain from about 5% to about 7% by weight, preferably about 6% by weight, of polydextrose.

The second fiber component of the subject ice cream base formulations is a soluble fiber from maltodextrin. This ingredient is a spray-dried powder produced by the pyrolysis and controlled enzymatic hydrolysis of cornstarch, is readily dispersible in water and carries no inherent flavor. This soluble fiber ingredient, which is unique to ice cream formulations, contributes solids and texture to the finished product. A preferred maltodextrin soluble powder product is Fibersol-2, available from Matsutani America, which contains from about 80% to 95% fiber. This material is present in from about 0.7% to about 1.5% by weight, preferably about 1%, by weight.

The subject ice cream formulations contain glycerin, which functions to reduce the freeze point of the ice cream, thereby providing a more creamy texture and scoopability characteristic of conventional premium ice cream. Glycerin is present in the subject ice cream base formulations in from about 5% to about 9% by weight, preferably about 7% by weight. Glycerin is seldom utilized in ice cream formulations and has not been utilized in the large quantity contained in the ice cream base formulations of the present invention.

The subject formulations contain whey protein concentrate, which is a whey product concentrated to significantly increase the protein content thereof. In general, whey protein concentrate will contain between 70% and 85% by weight whey protein, depending on the processing parameters and the manufacturer. It may be commercially available in various protein concentrations within this range. Preferably, the subject ice cream formulations contain whey protein concentrate having a protein content of about 80%, although concentrates of varying protein content could be utilized in equivalent quantity to give a comparable quantity of protein. Whey protein concentrate 80% is present in the subject formulations in from about 0.6% to about 1% by weight, preferably about 0.85% by weight. Whey protein concentrate provides dairy protein, increases solids and provides an improved creamy texture to the prepared ice cream according to the subject invention.

The subject formulations contain from about 0.4% to about 0.7% by weight, preferably about 0.55% by weight, of microcrystalline cellulose gel. Microcrystalline cellulose gel provides enhanced viscosity to the liquid ingredients in the preparation and also aids in the processing of the product. Additionally, the microcrystalline cellulose gel enhances both the taste and texture of the final ice cream product. As stated above, texture and mouth feel, in addition to taste, are very important criteria in the commercial acceptance of a low carbohydrate product, particularly one like ice cream that is expected to have a rich and creamy feel in the mouth.

The subject ice cream base formulations contain a number of colloid ingredients to enhance the blending of the fat and water and the overall texture of the product prepared therefrom. The first of these is xanthan gum, which is present in from about 0.1% to about 0.2% by weight, preferably about 0.15% by weight. The xanthan gum provides viscosity to the liquids in the processing. Further, the xanthan gum reduces the freeze point of the product and enhances both the taste and texture of the final product.

In addition to the xanthan gum, the subject formulations contain from about 0.1% to about 0.2% by weight, preferably about 0.15% by weight, of lecithin. The lecithin provides an emulsifier for the blending of the fat and water in the liquid processing. The lecithin further enhances the uniformity and texture of the ice cream. The subject formulations also contain from about 0.1% to about 0.2% by weight, preferably about 0.15% by weight, of a mixture of equal parts by weight locust bean gum and carrageenan gum. This mixture provides viscosity, reduces the freezing point and enhances both the taste and creamy texture of the ice cream products prepared from the subject formulations. Finally the subject formulations contain from about 1% to about 2% by weight, preferably about 1.2% by weight, of egg yolks which provide richness and enhance the creamy texture of the ice cream product.

The subject ice cream formulations contain a combination of sweetening agents so that they are sugar-free and yet have a sucrose taste much like that found in most conventional ice cream formulations that contain corn syrup and/or sugar. The first of these is the high intensity sweetener sucralose, and the second is acesulfame potassium. These two artificial sweeteners compliment each other to create the proper taste levels yet provide the product as no sugar added. In general, it is preferred for the two to be present in a ratio of two parts acesulfame potassium to about one part sucralose and for the two in combination to be present in from about 0.03% to about 0.06% by weight, preferably about 0.05% by weight.

It has been found that the ingredients enumerated above compliment each other in developing a ice cream base formulation that, when blended with a suitable flavor, is comparable in flavor, texture and mouth feel to conventional premium ice cream. This is considered surprising in that a number of these ingredients are not found in typical traditional ice cream formulations. It is also not conventional to prepare ice cream base formulations without milk. The subject formations may be utilized in all varieties of ice cream preparations and frozen confections from bulk ice cream to frozen novelties.

Ice creams prepared from the base formulations of the present invention may be flavored with a wide variety of flavors. With the emphasis being placed on carbohydrate-restricted diets, a substantial number of flavors have been developed that are low in carbohydrates and/or are sugar free. These flavors include the traditional flavors such as vanilla, chocolate, strawberry and the like as well as other conventional flavors, including novelty and seasonal flavors. It is such low carbohydrate/sugar-free flavors that are preferred for the ice cream base formulations of the present invention. It is contemplated that ice cream prepared from the ice cream base formulations of the present invention will contain from about 1.5% to about 10% by weight of a suitable flavor, wherein the percents are based on 100% of the base formula, i.e. 100 grams of base formulation with flavor would weight between 101.5 and 110 grams. Typically, the subject ice cream flavors will comprise from about 1.5% to about 5% by weight of ice cream prepared from the ice cream base formulations of the present invention. However, where the flavor contains solid material, such as candy bar chunks, nuts, sugar-free cookie pieces, sugar-free caramel, and the like, the percent by weight of the flavor based on the base formulation will be higher, e.g. up to about 10%.

In general, ice cream prepared in accordance with the present is comparable with conventional premium ice cream. Those of ordinary skill in the art will recognize that, although the ice cream base formulations in accordance with the present invention are very low in carbohydrate, the addition of a minor amount of carbohydrate, for example by the incorporation of a flavor, may be unavoidable. The specific type of carbohydrate and the quantity thereof will vary with the particular type of flavor and the quantity utilized.

It will also be appreciated that the subject formulations may contain other additives such as colorants. Colorants, and other additives that may be required, are typically provided in conjunction with the flavor. Flavors as are commercially available are prepared with colorants and whatever additional materials are required for their stability, dispersability and the like. The subject formulations additionally contain a mixture of mono- and di-glycerides of short chain fatty acids as an aid in the processing and blending thereof. Such processing aids are commercially available, for example, as PGX2 from Daniso Company. The subject ice cream base formulations contain from about 0.15 to 0.5, preferably about 0.3% by weight, of such processing aids.

The formulations of the present invention can be formulated into an ice cream base in accordance with traditional methods. Generally, the dry components of the formulation, i.e. the protein and fiber components and the colloids are mixed and thoroughly blended, then combined with a measured amount of the water, generally about 75% of the required amount, and thoroughly blended. Thereafter, the heavy cream and other non-aqueous components, i.e. the glycerin, egg yolks and lecithin, are blended and gradually added thereto with thorough mixing. The resultant mixture is pasteurized, typically at a temperature of from about 155° F. to about 170° F. for from about 30 minutes to about 15 minutes, depending on the temperature selected. The mixture is then homogenized utilizing conventional equipment to break up the coarse globules of fat thereby forming an emulsion wherein the fat droplets are typically smaller than one micron.

The surfactants present in the formulation act to maintain the micro-dispersion of the fat droplets in the emulsion. There are two types of surfactants in the ice cream formulations, daily proteins such as the whey protein concentrate and emulsifiers including the mono- and di-glyceride mixture, lecithin and the gums. These adsorb to the surface of the homnogenized fat droplets and stabilize the emulsion. Once the emulsion is formed and stabilized, the remainder of the water may be added thereto with mixing to bring the emulsion base to a final weight. It is preferred to add a portion, generally about half, of the mono-and di-glyceride component to the dry mixture prior to the initial blending with water as an aid in the processing thereof. The remainder is blended with the heavy cream mixture prior to combining it with the water mixture. Once the emulsion is brought to final weight, it is cooled to a temperature of about 41° F. (5° C.), below the melting point of the fat, which begins to crystallize, thereby forming a microstructure of the mixture. The resultant flowable emulsion may be shipped in bulk to commercial ice cream co-packers or directly converted into a finished ice cream product. In either instance, conversion to finished ice cream is carried out by blending a suitable flavor into the emulsion base followed by the conventional techniques of aeration and freezing. This is typically carried out by passing the flowable emulsion through a conventional device that forces air under pressure into the emulsion and releases it through an orifice into suitable containers or molds.

The flavors utilized to turn the base formulations of the present invention into finished ice cream products may be added at any time after pasteurization, preferably by blending into the formulation after the emulsion has been formed and it has been adjusted to a final weight. Those of ordinary skill in the art will appreciate that the flavors must be added after pasteurization because some flavors might not withstand the temperatures involved in the pasteurization process. The flavor is simply added to the formulation with sufficient blending in a chiller mixer to evenly disperse the flavor throughout the ice cream. Alternatively, the ice cream base formulation may be shipped in large containers for subsequent blending with appropriate flavors and repackaging.

The ice cream prepared from the formulations of the present invention have been found to be comparable in consistency, taste and mouth feel to conventional premium ice cream. The subject ice cream formulations are advantageous to the individual on a restricted carbohydrate diet as they are exceptionally low in carbohydrate content, and are additionally rich in fiber. The subject formulations provide a healthy alternative to traditional premium ice cream without the need to sacrifice taste or satisfaction.

The following examples further illustrate the current invention, but are not in any way intended as being limiting thereon:

### EXAMPLE 1

The following formulation was utilized to prepare low carbohydrate ice cream:

| Ingredient | Quantity in Grams |
|---|---|
| Heavy Cream | 410.0 |
| Purified Water | 412.0 |
| Soluble Dietary Fiber | 10.0 |
| (Fibersol 2, Matsutani America) | |
| Polydextrose | 60.0 |
| Whey Protein Concentrate | 8.5 |
| Glycerin | 70.0 |
| Egg Yolks | 12.0 |
| Sucralose | 1.5 |
| Acesulfame Potassium | 3.0 |
| Lecithin | 1.5 |
| Mono- and Di-Glyceride Mixture | 3.0 |
| Xanthan Gum | 1.5 |
| Microcrystalline Cellulose Gel | 5.5 |
| Mixture of Locust Bean Gum and Carrageenan Gum | 1.5 |
| Total | 1.000.0 |

The dry ingredients consisting of the soluble dietary fiber, polydextrose, whey protein concentrate, xanthan gum, mixture of locust bean gum and carrageenan gum, microcrystalline cellulose gel, acesulfame potassium, sucralose and one-half of the mono- and di-glyceride mixture were combined in a suitable mixing vessel and mixed until thoroughly blended. Approximately 75% of the purified water was gradually added thereto with mixing and the resulting mixture was blended until a vortex appeared therein. The heavy cream was separately mixed with the glycerin, egg yolks, lecithin and the remainder of the mono- and di-glyceride mixture and the mixture gradually added with continued mixing to the water mixture. Mixing was continued for 20 minutes after addition was completed.

The blended formulation was then pasteurized at 170° F. for twenty minutes and then forced through a conventional homogenizer to complete emulsification and reduce the size of the fat globules therein to one micron or less. The remainder of the purified water, which had been pasteurized, was then added to bring the formulation up to final volume and mixing was continued for a further twenty minutes. The resultant flowable emulsion base formulation may then be shipped in bulk or processed to prepare a finished ice cream product. For shipment, the base formulation is packaged in suitable bulk containers under clean fill, aseptic conditions.

### EXAMPLE 2

The following procedure may be carried out directly on the ice cream base formulation formed in Example 1, or on the formulation as received in bulk containers by a commercial ice cream co-packer. The formulation from Example 1 above is combined in conventional ice cream packing equipment with a suitable low carbohydrate and/or sugar-free flavor and solid ingredients, such as sugar-free caramel, nuts, sugar-free marshmallow, fruit, sugar-free cookie pieces and the like, and blended until uniform. The flavored ice cream is then passed from the blender into suitable forms or packages, in the process being aerated in accordance with conventional techniques by forcing air under pressure into the ice cream as it is being conducted to and flowing out of an orifice. The ice cream is then frozen at 25° F. and is ready for consumption. The resulting ice cream compares favorably with conventional premium ice cream.

1. An ice cream base formulation comprising:
a) from about 35% to about 45% by weight of heavy cream;
b) from about 37% to 45% by weight of water;
c) from about 5% to about 7% by weight of polydextrose;
d) from about 5% to about 9% by weight of glycerin;
e) from about 0.7% to about 1.5% by weight of maltodextrin soluble fiber
f) from about 0.6% to about 1% by weight of whey protein concentrate;
g) from about 0.4% to about 0.7% by weight of microcrystalline cellulose gel;
h) from about 0.1% to about 0.2% by weight of xanthan gum;
i) from about 0.1% to about 0.2% by weight of lecithin;
j) from about 0.1% to about 0.2% by weight of a mixture of locust bean gum and carrageenan gum;
k) from about 1% to about 2% by weight of egg yolks;
l) from about 0.15% to about 0.5% of a mixture of mono- and di-glycerides of short chain fatty acids; and
m) an artificial sweetener comprising sucralose and acesulfame potassium in a weight ratio of about 1:2.

2. An ice cream base formulation in accordance with claim 1, wherein said whey protein concentrate contains between about 70% and 85% by weight whey protein.

3. An ice cream base formulation in accordance with claim 1, wherein the heavy cream contains at least about 40% butterfat.

4. An ice cream base formulation in accordance with claim 1, wherein said formulation contains:
a) about 41% by weight of heavy cream; and
b) about 41% by weight of water.

5. An ice cream base formulation in accordance with claim 1, wherein said formulation contains:
c) about 6% by weight of polydextrose;
d) about 7% by weight of glycerin;
e) about 1% by weight of maltodextrin soluble fiber;
f) about 0.85% by weight of whey protein concentrate;
g) about 0.55% by weight of microcrystalline cellulose gel;
h) about 0.15% by weight of xanthan gum;
i) about 0.15% by weight of lecithin;
j) about 0.15% by weight of a mixture of locust bean gum and carrageenan gum;
k) about 1.2% by weight of egg yolks;
l) about 0.3% by weight of said mixture of mono- and di-glycerides of short chain fatty acids; and
l) from about 0.03% to about 0.06% by weight of said artificial sweetener

6. An ice cream base formulation in accordance with claim 5, wherein said formulation contains about 0.05% by weight of said artificial sweetener

7. A low carbohydrate ice cream comprising the ice cream base formulation of claim 1 and a suitable flavor.

8. A low carbohydrate ice cream formulation in accordance with claim 7, wherein said ice cream contains from about 1.5% to about 10% by weight of said flavor, based on the total weight of said base formulation.

9. A low carbohydrate ice cream comprising the ice cream base formulation of claim 2 and a suitable flavor.

10. A low carbohydrate ice cream formulation in accordance with claim 9, wherein said ice cream contains from about 1.5% to about 10% by weight of said flavor, based on the total weight of said base formulation.

11. A low carbohydrate ice cream comprising the ice cream base formulation of claim 3 and a suitable flavor.

12. A low carbohydrate ice cream formulation in accordance with claim 11, wherein said ice cream contains from about 1.5% to about 10% by weight of said flavor, based on the total weight of said base formulation.

13. A low carbohydrate ice cream comprising the ice cream base formulation of claim 4 and a suitable flavor.

14. A low carbohydrate ice cream formulation in accordance with claim 13, wherein said ice cream contains from about 1.5% to about 10% by weight of said flavor, based on the total weight of said base formulation.

15. A low carbohydrate ice cream comprising the ice cream base formulation of claim 5 and a suitable flavor.

16. A low carbohydrate ice cream formulation in accordance with claim 15, wherein said ice cream contains from about 1.5% to about 10% by weight of said flavor, based on the total weight of said base formulation.
